(19) United States
(12) Patent Application Publication
(10) Pub. No.: US 2022/0312693 A1
(43) Pub. Date: Oct. 6, 2022

(54) OUTWARD ANGLED PLANT SUPPORT APPARATUS AND SYSTEM

(71) Applicants: John Edward Aiken, Monroeville, PA (US); Edward Scott Carlson, Delmont, PA (US)

(72) Inventors: John Edward Aiken, Monroeville, PA (US); Edward Scott Carlson, Delmont, PA (US)

(21) Appl. No.: 17/844,699

(22) Filed: Jun. 20, 2022

Related U.S. Application Data
(63) Continuation-in-part of application No. 16/505,281, filed on Jul. 8, 2019.

(51) Int. Cl. A01G 17/06; A01G 9/12

(52) U.S. Cl. CPC A01G 17/06; A01G 9/12

(57) ABSTRACT

The present invention provides elongated structures that maximize the use of minimal ground space or pot soil by providing a generally vertical outward-sloping multiple-cord trellis such as to offer increasing volume and area for plant foliage with height, which is adjustable to the user's desire. A compact kit includes at least four elongated leg members, and at least two elongated support rods, and can be assembled with included Tees into structures up to approximately twice as wide at the top as at the base where the plants begin growing in soil. Once installed, flaccid replaceable cords incline generally outward and upward to top horizontal support rods and engage with climbing plants to assist growth generally vertically and even horizontally across the top.

### CONTINUATION IN PART TO RELATED APPLICATION

This application is a continuation-in-part of U.S. Utility patent application Ser. No. 16/505,281 filed Jul. 8, 2019, which is related to and claims priority in part from U.S. Provisional Patent Application Ser. No. 62/694,480 filed Jul. 6, 2018. All of the above, each in their entirety, are incorporated herein by reference.

### FIELD OF THE INVENTION

The present invention relates, in general, to growing tall or wining plants that benefit from a support system as they grow taller and, more particularly, this invention relates to an improved system and trellis-like apparatus that provides an elongated structure that expands growing area and volume at a greater-than-linear rate with height from a minimal footprint.

### BACKGROUND OF THE INVENTION

Prior to the conception and development of the present invention, the marketplace and patent literature are replete with an abundance of devices and systems for aiding the growth of climbing plants or those that benefit from a system or apparatus to assist their generally vertical growth, for both tomatoes and wining plants. Most ubiquitous is the wire tomato cage that may have 3 or 4 horizontal rings of increasing diameter attached to 3 or 4 wire legs that must be pressed into the ground adjacent the plant. They are notorious for rusting, the legs getting bent on any rocks in the ground, and frequently falling over from plant weight. They, like many other cage or ring types, rely on passive support by the plants draping themselves over the rings and do not function like a trellis,. There are others like a tomato tower that expanded area and volume linearly with height in a strictly vertical direction.

### PRIOR ART

Hamann in U.S. Pat. No. 8,272,160 discloses a vine stand that includes a wire cage which curves outward, and then back in such that at the top it has about the same or less cross sectional area as at the base. There are many obelisk or pyramid-type plant and vine growing structures that come nearly to a point at the top, thereby offering decreasing volume as height increases. Schaible in U.S. Pat. No. 1,974,367 teaches the use of vertical strings for a vine, but they come to a point at the top. Y-shaped trellises have been use for grapes for decades, but they offer greater growth volume only near the top. Trellis designs for growing hops have been described with strictly vertical wires or twine, such as by Broughton in US 542,821. Summers in U.S. Pat. No. 6,378,245 teaches a kit employing a braced T-shaped pole for supporting strictly vertical netting, and it would not be amenable to sloping in any direction. In US published application 2017/0127621, Harger discloses a plant trellis system for a bucket that can have somewhat vertical legs that can be at variable angles. It can be designed for a round or square bucket, but the clamps for the bucket must be made for a specific size and shape. Thus, Harger's system lacks versatility and is not for plants in the ground.

The prior art apparently places priority on the greater stability of being wider at the bottom and declines to take on the challenges of sloping outward in the generally upward direction. Little, if any, of the prior art teaches optimizing the use of a limited amount of ground plant area with greater air and sunlight exposure, easy picking of the vegetable product, or growing on a steep hillside. There are raised bed products on the market with trellis attachments, but those are always short and straight vertical. For whatever reasons, others have overlooked issues such as crowding of growth with increasing height, growing area across the top, and ease of picking. Furthermore, trellis designs ignore a major nemesis of urban, suburban, and rural gardening—deer devouring the vegetation.

### OBJECTS OF THE INVENTION

It is, therefore, one of the primary objects of the present invention to provide a rectangular vertical gardening support system with space expanding with greater-than linear proportion to height as plants grow up along the attached cords of a string trellis.

Another object of the present invention is to provide a durable, relatively inexpensive V-shaped vertical gardening system for climbing plants as well as non-wining tall plants.

Yet another object of the present invention is to provide a vertical gardening unit that can easily adapt to protection of vegetation from deer and other animals.

Still another object of the present invention is to provide a trellis apparatus efficiently adaptable to steep hillsides.

An additional objective of the present invention is to make available a compact kit product that can be erected into an adjustable height trellis.

Yet still another objective of the present invention is to provide support for climbing plants that is inexpensive and can be disposed of with dead plants and replaced the next year.

An additional objective of the present invention is to provide enhanced support for upward growing plants by employing both active and passive support.

### SUMMARY OF THE INVENTION

The present invention conveniently maximizes the use of a minimal foot print by providing at least two outward-sloping cords or such as to provide volume for plant foliage increasing a greater-than-linear rate with height, which may be fixed or adjustable to the user's desire. A compact kit can be assembled into a structure approximately twice as wide at the top as at the base where the plants begin growing in soil. Flaccid reusable or disposable cords inclined generally downward and inward from top horizontal rods support wining plants to grow generally vertically and even horizontally across the top.

In one preferred embodiment, the structure is basically an elongated Y and will include an outer net to protect against animals and create a protected space between it and the foliage.

### BRIEF DESCRIPTION OF THE DRAWINGS

FIG. 1 provides a perspective schematic view of a preferred embodiment of the present invention in an elongated Y.

FIG. 2 is a perspective view of an alternative embodiment of the present invention incorporating protection from plant-eating animals.

FIG. 3 is an end elevation view of the preferred embodiment of the elongated trellis apparatus also configured to offer much more area across the top relative to the ground space.

FIG. 4 is an end elevation view of yet another alternative embodiment of the elongated trellis apparatus also configured to offer much more area across the top relative to the ground space.

FIG. 5 is an elevation end view of a less preferred embodiment of the present invention.

FIG. 6 provides a plan view of a kit with the typical parts for the erecting the structure of the present invention.

FIG. 7 provides a side perspective view of an application of the present invention to plants growing in containers.

FIG. 8 is a perspective end view of the application of the present invention also shown in FIG. 7.

FIG. 9 provides a perspective view of the elongated Y structure for an exemplary use of one embodiment of the present invention on the ground of a typical outdoor garden.

FIG. 10 provides an end perspective view of an alternative system employing the apparatus of the present invention.

FIG. 11 provides a simplified elevation view of an additional embodiment illustrating how one extra horizontal support rod in a kit can enable a second kit to triple the length of a first kit.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

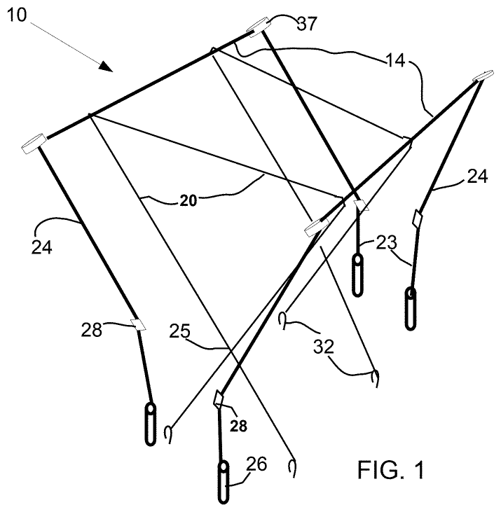

Parts of the invention in FIG. 1 and following are described in this reference list, which may not be complete:
10 the invention in general
14 frame horizontal rod
20 trellis cords
21 trellis cord branch
22 optional top cross brace
23 Vertical leg section
24 Angled leg section
25 V notch created by intersecting cords
26 ground sleeves
28 rigid Elbow fitting
32 ground staples
36 Extra Tee Fitting
37 Tee fitting
40 protective net—chicken wire or similar
50 Ground or growing medium

Referring initially to FIG. 1, a preferred embodiment of the present invention, shown generally as 10, is illustrated in this perspective view. It is primarily used to support taller growing plants such as pole beans so as to keep them off the ground and climbing upward but not toward each other. The vertical leg sections 23 are supported in ground support sleeves 26, which have an inside diameter two to ten percent wider than the outside diameter of the vertical leg sections 23, and are driven into the ground, or the growing medium in a container. The vertical leg sections 23 connect with a angled leg sections with approximately 22-degree rigid elbows 28 such that opposing angled leg portions 24 slope away from each other to create greater volume for supported vegetation than one would get with straight vertical legs. The top ends of the angled leg sections 24 connect with a standard slip-joint Tees 37, and two of these Tees support a horizontal support rod 14 typically 4-ft long. A four-legged structure with two horizontal rods 14 can then support multiple flaccid cords 20, which have a top horizontal segment which comes under tension thus stabilizing the structure by limiting the separation of the horizontal rods 14. Vining plants can also grow across the top. The cords 20 have a crossing point 25 and then are anchored to the ground or container with staples or pegs 32.

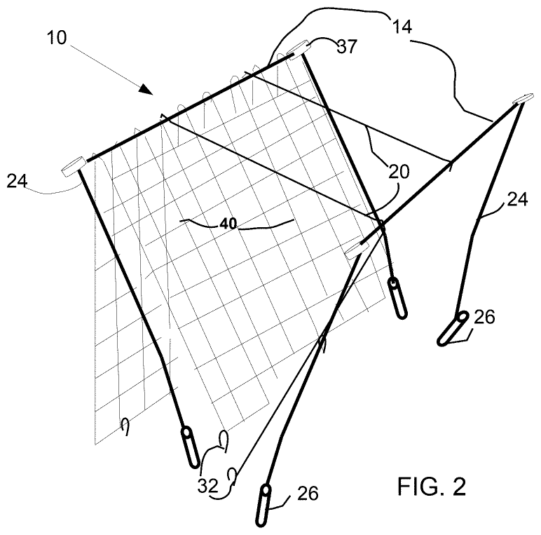

FIG. 2 is a perspective view of an alternative embodiment of the present invention 10 incorporating protection from plant-eating animals. A protective net 40 is draped over the upper horizontal rods 14 and preferably is attached at the ground 50, with staples or pegs 32. A significant feature of the invention is that this protective net 40 can be secured at the ground a substantial distance from the ground support sleeves 26 such that there is considerable space between the net and any vegetation extending in that direction so that deer or other animals cannot reach it. Preferably, one continuous net 40 is draped over a horizontal rod 14 and extends down to and is held near the ground with anchors 32 adjacent the plants to provide a growing and support element for the plants. For clarity, the net is shown only on one of the horizontal rods 14, but typically it would be on the other side as well. In this embodiment, the legs 24 are one straight tube sloping outward and supported in ground sleeves 26. The horizontal rods 14 are held at the desired separation by the top cords 20, which are in tension.

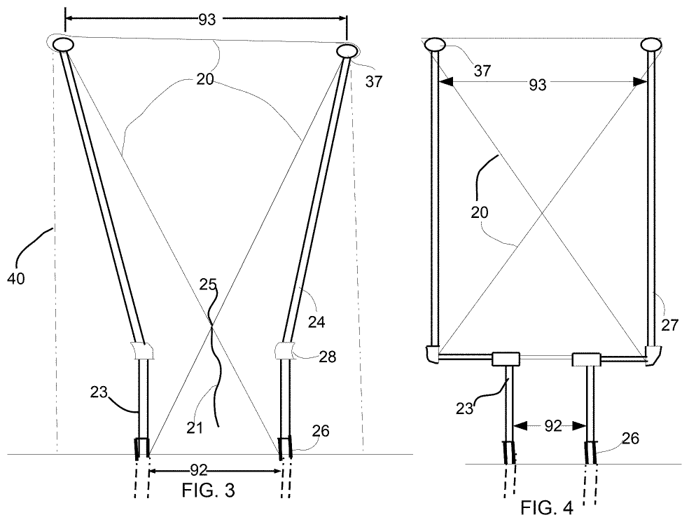

FIG. 3 is an end elevation view of the preferred embodiment per FIG. 1 of the elongated trellis apparatus configured to offer much more area across the top relative to the ground space. Vertical leg sections 23 are supported within a slightly wider diameter ground sleeve 26 and connect at the upper end with the angled leg sections 24 via a rigid elbow fitting 28. This will result in a generally more stable structure than one angled from ground level. The slope of the angled leg portions will be in the range of 10 to 30 degrees from straight vertical and away from the opposing angled leg sections. Preferably, the rigid elbow fittings 28 has a 22.5-degree angle and the separation at the top 93 is at least double that at ground level 92. The angled leg sections connect via a slip Tee 37 to the horizontal rods 14. Elongated flaccid cords 20 slope outward from the plant base area and provide the climbing support for plants and also help reinforce the structure by tying to one horizontal rod 14, coming across the opposing horizontal rod, and then anchored near the ground or a plant container. At the cross over 25 of the cords 20, an optional branch portion 21 is tied there to provide a free end to tie onto plant stems, particularly for plants that do not climb the trellis strings or nets, such as most tomatoes. All known cage, wire, and net trellises rely on simply passive support for the plants that vine onto the support, or just lean against it to garner some support. The horizontal rods 14 provide the upper support for the elongated flaccid cords 20, and also for protective netting 40 to keep deer and rabbits away from the growing plants. There are multiple ways to secure the cords 20 near the base of the plants, such as ground staples or pegs. The elongated flaccid cords 40 are formed from one of string, twine, plastic cord, and combinations thereof. By flaccid, it is meant, within the scope of the invention, that such cords are flexible yet essentially limp, not resilient or wire-like. Further evidence of being “flaccid” is that upon attempting to hold any length greater than 10 cm generally vertically above the hand will result in the cord drooping downward with almost none above the hand. Climbing plants have shown an affinity to the flaccid cords of the present invention, in spite of their smooth surface. The preferred flaccid cords do not have a round cross section, but rather oval with an aspect ratio greater than 2. It can be purchased in spools of 100 yards normally, and is often called a craft lace made of a polyolefin.

FIG. 4 is an end elevation view of yet another alternative embodiment of the elongated trellis apparatus also configured to offer much more space across the top 93 relative to the ground space 92. In this configuration, the upper leg section 27 is also vertical and requires a Tee fitting as well as a 90-degree elbow to connect with the lower vertical leg section 23. The strings 20 of the present invention provide the passive support of a member to which wining plants can entwine, but also enable active support by tying the free end of 21 to a plant stem.

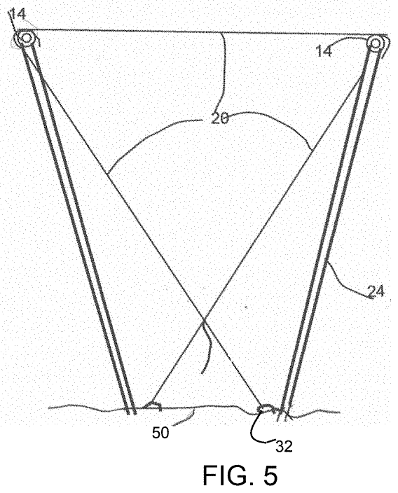

FIG. 5 is an elevation end view of a less preferred embodiment of the present invention. The tubular angled leg members 24 are secured in the ground 50 by one of any various means, such as a rod or tube driven into the ground at an angle. The cords 20 are draped over the horizontal rods 14 and cross over near the center at about one third of the height, and the two free ends are secured to the ground 50 with a pegs or staples. The present invention contrasts considerably from existing art in the way it expands growing volume non-linearly in the vertical direction from a minimal footprint while providing support for vertically growing plants, and solving concerns about stability.

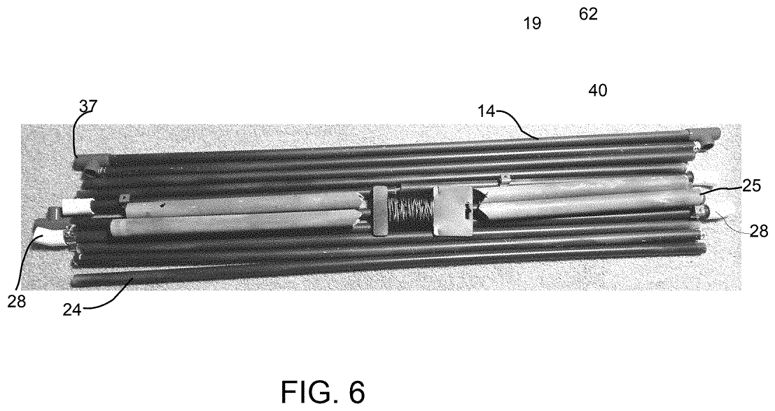

FIG. 6 provides a plan view of a kit version of the present invention with the typical parts for the erecting the structure of the present invention. The leg sections 23 and 24 and horizontal support rods 14 come as tubular elements parallel to one another for compact storage and shipping. Four support sleeves 26 are included as are the Tee fittings 37 and the rigid elbows 28, which have an angle of less than 30 degrees. There are also ground staples 32 and a spool of flaccid cord 20. Extra flaccid cord is provided so that the cords and plants can be cut down together at the end of the season and new cords installed next year. Optionally, the kit comes with a pair of extra horizontal rods allowing modular expansion of a first 4-foot long structure another 8 feet with just one additional kit.

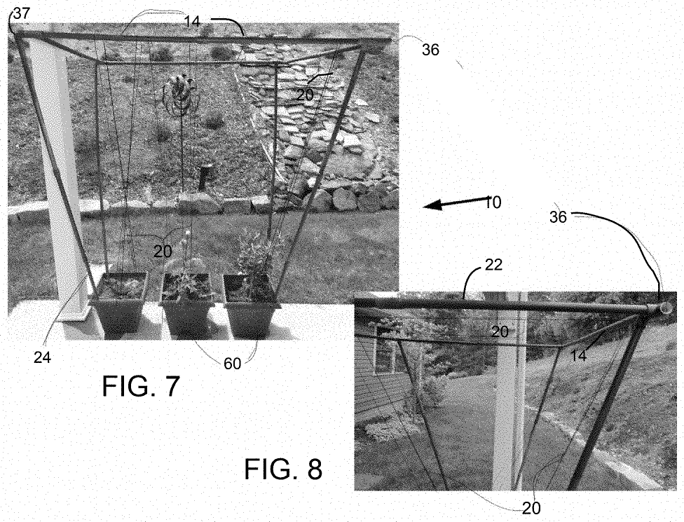

FIG. 7 provides a side perspective view of an application of the present invention 10 to plant growing in containers 60. The legs 24 can be pushed into the soil in the containers 60 as far as possible. The elongated flaccid cords 20 are then strung over the horizontal rods 14, made of tubular sections 27, and ends attached to the pot 60 or something in it.

FIG. 8 is a perspective end view of the application of a less-preferred embodiment the present invention, also shown in FIG. 7. An additional Tee fitting 36 at the top end where the cross brace 22 connects allows for additional horizontal rods 14 to be attached allowing for a modular system of extensions.

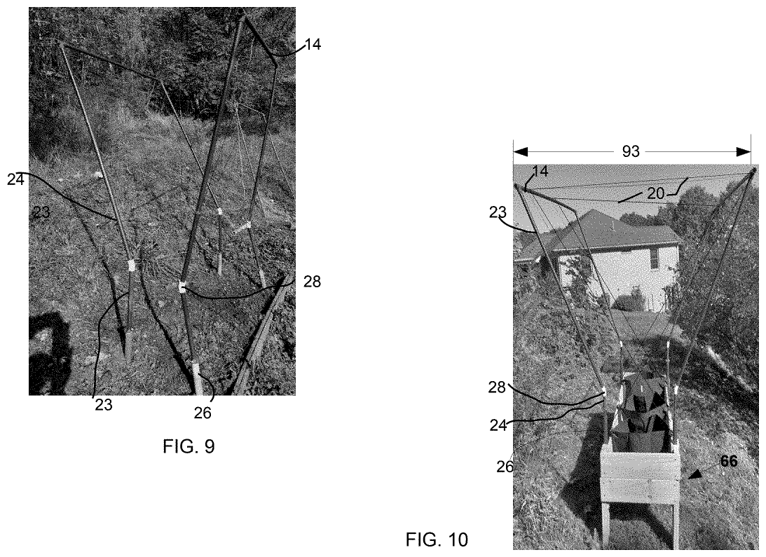

FIG. 9 provides a perspective view of the elongated Y structure for an exemplary use of one embodiment of the present invention on the ground of a typical outdoor garden. The vertical leg portions 23 slip into support sleeves 26. At the upper end, the 22-degree elbow 28 connects to the angled leg portion 24. At the upper end of two angled leg portions 24 about 4-feet apart, a Tee fitting 37 connects a horizontal rod 14 to them.

FIG. 10 provides an end perspective view of an alternative system employing the apparatus of the present invention. The elongated Y structure is mounted to an elevated raised bed 60. The vertical leg portions 23 slip into support sleeves 26, which are fixed to the legs of the box structure. This example illustrates that the support sleeves are not always in the ground, although that is most common. At the upper end of leg portions 23, the 22-degree elbows 28 connect to the angled leg portions 24. At the upper end of two angled leg portions 24 about 4-feet apart, a Tee fitting 37 connects a horizontal rod 14 to them. As in other examples, flaccid cords 20 allow means for supporting plants as well as constricting movement of the horizontal rods 14 thus maintaining them at the chosen separation.

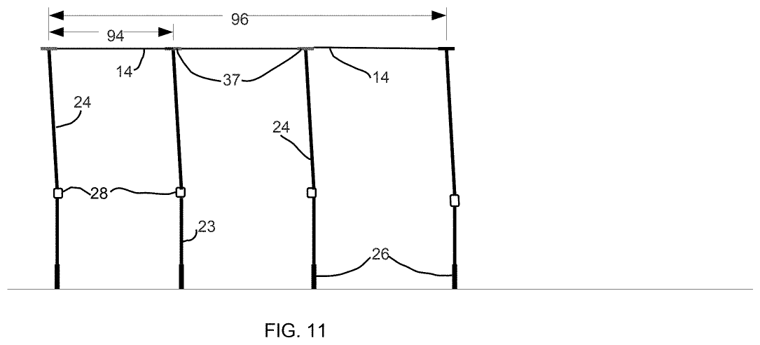

FIG. 11 provides a simplified elevation view of one side of an elongated trellis structure illustrating how two extra horizontal support rods 14 in a kit can enable a second kit to triple the length 96 of a first kit 94. Horizontal support rods and angled leg sections 24 are identical in all respects. Combined, there are seven total per side for 14 needed for the entire three-module structure. A single module kit has six and two would have 12. No additional elbows 28 or Tees 37 would be needed for two kits to span triple the distance of one. Thus with one additional horizontal support rod per kit, there is the capability to expand to triple the length of the first kit with just one additional kit. This description and FIG. 11 would provide instructions to a user on this non-obvious capability.

While a presently preferred and alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

We claim:

1. A plant support trellis providing expanding growth volume and plant contact area in the vertical direction comprising:
a) at least two elongated leg members;
b) at least one horizontal support rods;
c) at least two corner connector fittings frictionally engageable with an end of one of said legs and an end of said horizontal support rods; and,
d) one of a net and a multiplicity of elongated flaccid cords configured for attachment at one end adjacent the growing medium and with at least one of the horizontal rods at an opposing end.

2. The plant support trellis of claim 1 wherein said support trellis further includes at least 2 ground support stakes with an outside diameter permitting said rods to fit inside a hollow end of said leg members.

3. The plant support trellis of claim 1 wherein said support trellis includes four elongated leg members and two horizontal support rods.

4. A plant support trellis providing expanding growth volume and plant contact area in the vertical direction comprising:
e) at least four elongated leg sections;
f) at least two horizontal support rods;
g) at least four Tee fittings frictionally engageable with an end of one of said legs and an end of said horizontal support rods; and,
h) a multiplicity of elongated flaccid cords configured for attachment at one end adjacent the growing medium and with at least one of the horizontal rods.

5. The plant support trellis of claim 4 wherein said plant support trellis includes four Tee fittings, eight leg sections having a first outside diameter, and four rigid elbow fittings configured to frictionally engage over the first outside diameter and connect ends of two of the leg sections.

6. The plant support trellis of claim 5 wherein each of said four rigid elbow fittings of said plant support trellis form a fixed angle of less than 30 degree.

7. The plant support trellis of claim 5 wherein said plant support trellis further includes four elongated rigid support sleeves having an inside diameter 10 to 20 percent greater than first outside diameter.

8. The plant support trellis of claim 4 wherein said support trellis further includes at least one net member being of sufficient length to attached to a horizontal rod and reach a root area of a plant to be supported by said plant support trellis.

9. The plant support trellis of claim 5 wherein said flaccid cords further include a branch portion configured for a free end to be tied onto a branch of a plant to be supported.

10. The plant support trellis of claim 1 wherein said elongated leg sections and said horizontal support rods consist of tubular elements of dissimilar lengths

11. A kit for erecting a plant support trellis, said kit comprising:
a. at least four elongated leg members;
b. at least two horizontal support rods;
c. at least four Tee fittings frictionally engageable with an end of one of said leg members and an end of said horizontal support bar; and
d. a compact supply of flaccid cords.

12. The kit of claim 11 wherein said elongated leg members can each be assembled from two tubular leg sections and a rigid elbow fitting at less than a 30 degree angle.

13. The kit of claim 11 further including rigid sleeve members configured for supporting leg sections.

14. The kit of claim 11 further including one extra horizontal support rod and instructions how to enable one additional kit to triple the length of a first installed kit.
